(19) United States
(12) Patent Application Publication
(10) Pub. No.: US 2017/0047630 A1
(43) Pub. Date: Feb. 16, 2017

(54) LITHIUM BATTERY MODULE

(71) Applicant: AMITA TECHNOLOGIES INC LTD., Taoyuan City (TW)

(72) Inventor: Jing-Yih CHERNG, Taoyuan City (TW)

(21) Appl. No.: 15/150,283

(22) Filed: May 9, 2016

(30) Foreign Application Priority Data
Aug. 10, 2015 (TW) 104126011

(51) Int. Cl. H01M 16/00; H01M 10/42; H01M 2/12; H01M 10/0525

(52) U.S. Cl. CPC H01M 16/00; H01M 10/0525; H01M 10/425; H01M 2/1229

(57) ABSTRACT

A lithium battery module includes a sealed housing, a fixture and at least one soft-shell capacitor assembly. A one-way exhaust structure is disposed on the sealed housing. The fixture is accommodated in the sealed housing. The at least one soft-shell capacitor assembly is disposed on the fixture. The soft-shell capacitor assembly is pressed and fixed by the fixture while a vent is formed on the soft-shell capacitor assembly. Thereby, the sealed housing and the one-way exhaust structure are capable of isolating the environment and controlling the pressure relief and exhaust.

### TECHNICAL FIELD

The disclosure relates to a lithium battery, more particularly to a lithium battery module capable of exhaust and pressure relief.

### BACKGROUND

A common lithium battery is generally made by multiple battery cells connected in series or in parallel. Normally the battery cells need to be disposed inside a housing for protection. When the battery cells are not operated properly (e.g. overcharge), the reaction of electrodes and electrolytes in the battery cells occurs and this generates combustible gases. The combustible gases enclosed in the housing may result in increased pressure and may leads to deformation of the housing and explosion of the combustible gases. Arranging pressure relief holes formed on the housing may solve the problems. However, multiple battery cells exhausting combustible gases at the same time can be dangerous because a large amount of combustible gases escape outside and may be ignited. Moreover, water vapor from the environment may penetrate into the inside of the housing via the pressure relief holes and therefore damages the battery cells. Hence, the disposal of the combustible gases is a crucial issue to deal with.

### SUMMARY

The disclosure provides a lithium battery module capable of exhaust and pressure relief.

The disclosure provides a lithium battery module comprising a sealed housing, a fixture and at least one soft-shell capacitor assembly. A one-way exhaust structure is disposed on the sealed housing. The fixture is accommodated in the sealed housing. The at least one soft-shell capacitor assembly is disposed on the fixture. The soft-shell capacitor assembly is pressed and fixed by the fixture while a vent is formed on the soft-shell capacitor assembly.

Preferably, the one-way exhaust structure comprises an air passage, a rubber sleeve and a pressing plate, the air passage is formed in a manner outwardly protruding from the sealed housing while at least one through hole is formed on the air passage, the rubber sleeve is sleeved on the air passage to make the through hole airtight, the pressing plate is fastened with the cover and presses and fixes the rubber sleeve to the air passage. The vent of each soft-shell capacitor assembly is disposed with an absorbent structure for electrolyte

Preferably, the fixture comprises a pair of pressing plates and a plurality of rods, two ends of each rod are respectively connected to each pressing plate, and the soft-shell capacitor assembly is sandwiched between the pair of pressing plates. The number of the soft-shell capacitor assemblies is plural, and the soft-shell capacitor assemblies are stacked up in layers between the pair of pressing plates. The fixture comprises a plurality of elastic pieces each sandwiched between the adjacent soft-shell capacitor assemblies.

Preferably, the number of the soft-shell capacitor assemblies is plural, and the soft-shell capacitor assemblies are stacked up in layers at the fixture. The fixture comprises a plurality of elastic pieces each sandwiched between the adjacent soft-shell capacitor assemblies.

Preferably, further comprising a control circuit board accommodated in the sealed housing, the soft-shell capacitor assemblies being electrically connected to the control circuit board. The vent is disposed with a one-way exhaust structure. The soft-shell capacitor assembly comprises a soft-shell, a plurality of electrodes is accommodated in the soft-shell while lithium electrolyte is filled in the soft-shell to make the electrodes be immersed in the lithium electrolyte, and the vent is formed on the soft-shell. The vent is disposed with a one-way exhaust structure. An inner surface of the sealed housing is covered by waterproof layer which comprises metal materials

In the lithium battery module of the disclosure, the sealed housing provides a space isolated from the environment for storing the soft-shell capacitor assembly. The sealed housing is able to block water vapor and extend the lifespan of the soft-shell capacitor assembly The combustible gases generated by the soft-shell capacitor assembly can be exhausted out of the lithium battery module via the one-way exhaust structure on the sealed housing. During the exhausting process, the sealed housing can be a buffer space to avoid excessive combustible gases going into the environment in a short time, thereby reducing the possibility of ignition.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective view of the lithium battery module according to a preferred embodiment of the disclosure;

FIG. 2 is a schematic view of the one-way exhaust structure of the lithium battery module according to a preferred embodiment of the disclosure;

FIG. 3 is an exploded view of the lithium battery module according to a preferred embodiment of the disclosure;

FIG. 4 is a sectional view of the lithium battery module according to a preferred embodiment of the disclosure;

FIG. 5 is a schematic view of the operation of the one-way exhaust structure of the lithium battery module according to a preferred embodiment of the disclosure; and

FIG. 6 is a schematic view of the soft-shell capacitor assembly of the lithium battery module according to a preferred embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

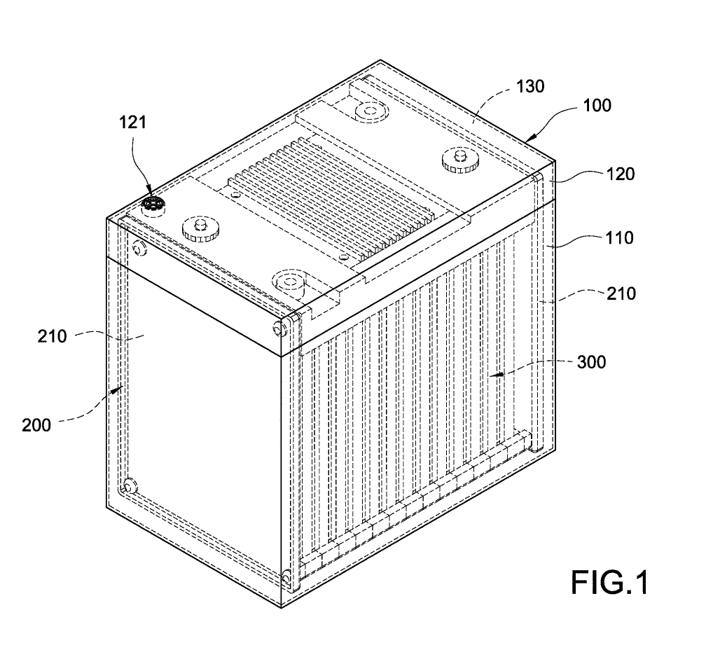

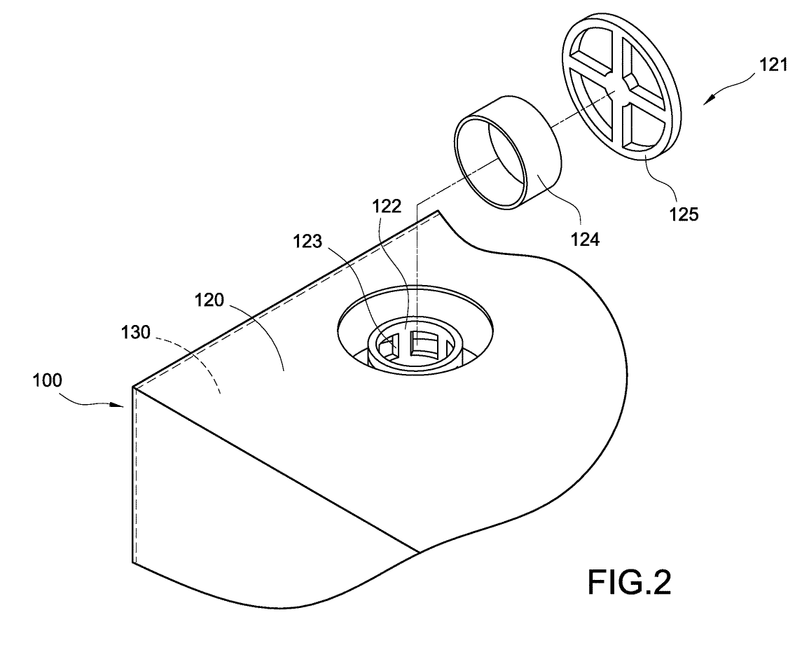

Referring to FIG. 1 to FIG. 3, a preferred embodiment of the disclosure provides a lithium battery module comprising a sealed housing 100, a fixture 200, at least one soft-shell capacitor assembly 300 and a control circuit board 400.

The sealed housing 100 comprise a box 110 and a cover 120. The box 110 has an opening 111 while the cover 120 covers the opening 111 for closing the box 110. The inside surface of the sealed housing 100 is covered by a waterproof layer 130 which comprises metal materials. In this embodiment, the waterproof layer 130 is a metal foil. The waterproof layer 130 is for preventing the outside water vapor from penetrating into the housing 100. The cover 120 is disposed with a one-way exhaust structure 121 for the gases inside the sealed housing 100 to go through and come out of the sealed housing 100. In this embodiment, the one-way exhaust structure 121 comprises an air passage 122 outwardly protruding from the cover 120. At least one through hole 123 is formed on the lateral side of the air passage 122. A rubber sleeve 124 is sleeved on the outside of the air passage 122 and covers the through hole 123 to make the through hole 123 airtight. The one-way exhaust structure 121 further comprises a pressing plate 125 which is preferably to be hollow. The outer edge of the pressing plate 125 is fastened with the cover 120 while it presses and fixes the rubber sleeve 124 to the end of the air passage 122.

The fixture 200 is accommodated in the sealed housing 100 and comprises a pair of holding plates 210, a plurality of rods 220 and a plurality of elastic pieces 230. In this embodiment, each rod 220 is preferably to be a screw and two ends of each rod 220 are connected to the holding plates 210 respectively so the pair of holding plates 210 are locked and fixed.

The soft-shell capacitor assembly 300 is disposed on the fixture 200. In this embodiment, the number of the soft-shell capacitor assembly 300 is preferably to be multiple. These soft-shell capacitor assemblies 300 are stacked up in layers between the pair of holding plates 210 of the fixture 200. Each elastic piece 230 is arranged to be sandwiched between the adjacent soft-shell capacitor assemblies 300 to make the soft-shell capacitor assemblies 300 be held and fixed.

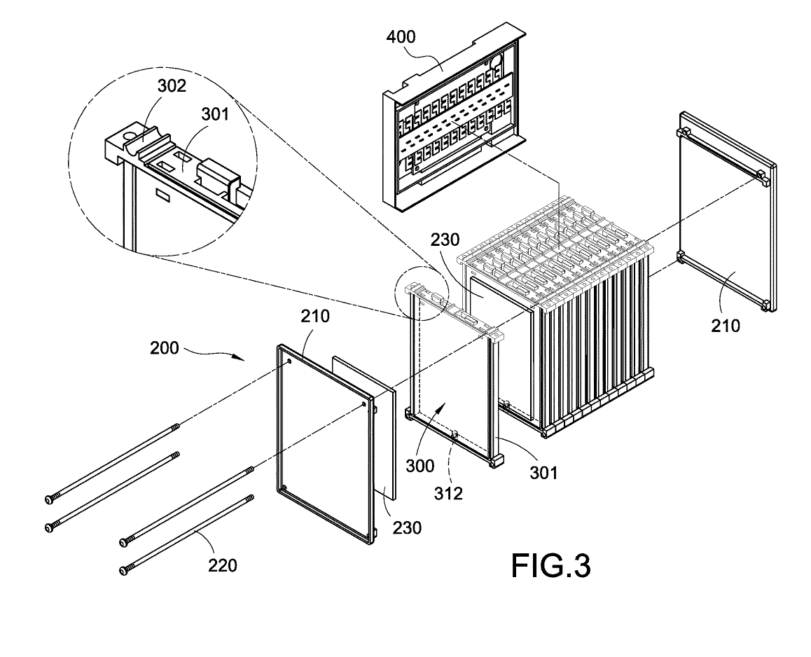

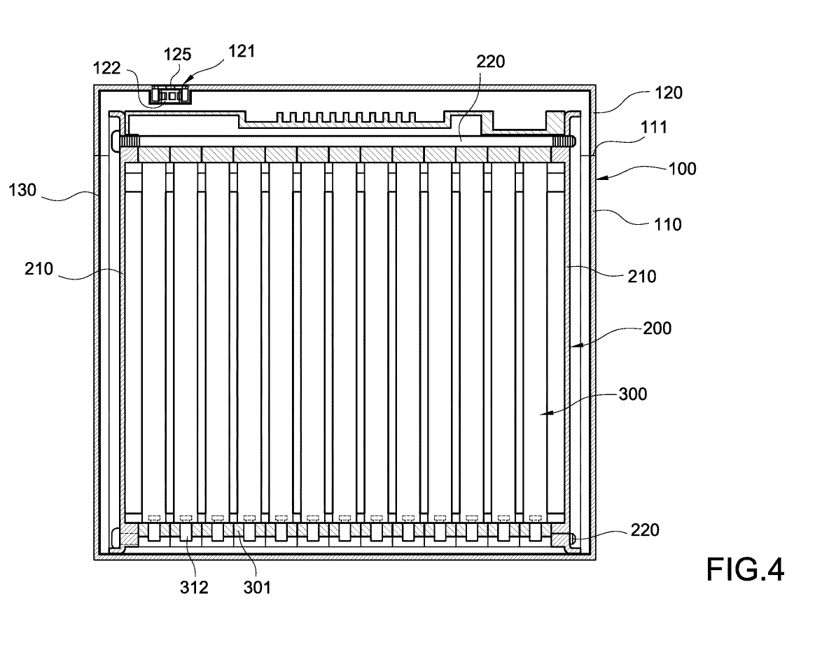

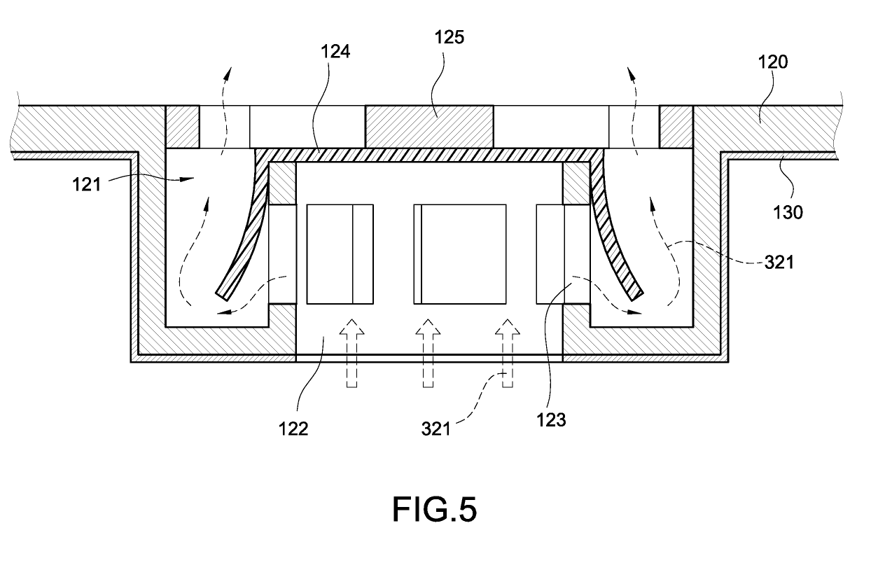

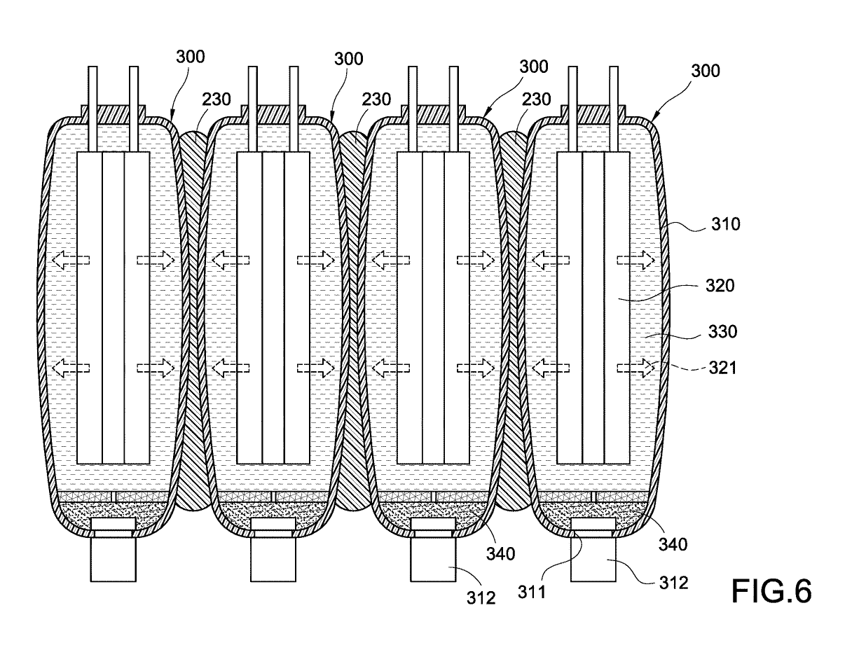

Referring to FIG. 3 to FIG. 6, each soft-shell capacitor assembly 300 comprises a frame 301 and a soft-shell 310. In this embodiment, the frames 301 is inside the sealed housing 100 so a plurality of compartments are formed in the sealed housing 100. Each compartment is for fixing at least one soft-shell 310. The soft-shell 310 may be a bag made of plastics or made of plastic and metal foil composite. A plurality of electrodes 320 is accommodated in the soft-shell 310 while lithium electrolyte 330 is filled in the soft-shell 310 to make the electrodes 320 be immersed in the lithium electrolyte 330. The soft-shell 310 is fixed in the frame 301. The outer edge of the frame 301 is disposed with a plurality of positioning grooves 302 corresponding to the rods 220 of the fixture 200. The positioning groove 302 is for the rod 220 to be mounted in for positioning the soft-shell capacitor assembly 300. The reaction of the electrodes 320 and the lithium electrolyte 330 generates gases to make the soft-shell 310 expand. The expanded soft-shell 310 presses the elastic piece 230 and thus makes the soft-shell 310 more stable. A vent 311 is formed on each soft-shell 310 for exhausting the gases inside the soft-shell 310. Preferably, the vent 311 is formed near the bottom of the box 110. This way, the vent 311 is inside the sealed housing 100 and relatively away from the one-way exhaust structure 121 of the cover 120. The inside of the soft-shell 310 is disposed with an absorbent structure 340. In this embodiment, the absorbent structure 340 is preferably a sponge. The absorbent structure 340 is arranged at the inner side of the vent 311. When the soft-shell capacitor assembly 300 exhausts gases via the vent 311, the absorbent structure 340 absorbs the lithium electrolyte 330 in the gases to avoid the leakage of the lithium electrolyte 330. The vent 311 is preferably disposed with a one-way valve 312 of which a predetermined release pressure should be less than the pressure of the pressing of the housing 100 or the fixture 200 but greater than the predetermined release pressure of the one-way exhaust structure 121. This may avoid backflow of the gases exhausted.

Referring to FIG. 1 to FIG. 3, the control circuit board 400 is accommodated in the sealed housing 100. The soft-shell capacitor assembly 300 may be electrically connected to the control circuit board 400 in series or in parallel, thereby charging or discharging each soft-shell capacitor assembly 300 via the control circuit board 400.

Referring to FIG. 1 to FIG. 4, when the soft-shell capacitor assembly 300 generates combustible gases 321 due to abnormal operation or mechanical aging, the combustible gases 321 is exhausted to a place inside the sealed housing 100 via the on-way valve 312 on the soft-shell capacitor assembly 300. When the combustible gases 321 in the sealed housing 100 reach a predetermined pressure, they can be exhausted out of the sealed housing 100 via the one-way exhaust structure 121 of the cover 120. In this embodiment, the rubber sleeve 125 is outwardly stretched only after the combustible gases 321 in the sealed housing 100 reach a predetermined pressure. Thereby, the combustible gases 321 in the sealed housing 100 can be exhausted via the through hole 123 of the air passage 122. In the sealed housing 100, the vent 311 of the soft-shell capacitor assembly 300 and the one-way exhaust structure 121 of the cover 120 are arranged in a manner away from each other. Thereby, the distance of them, acting as a buffer, is extended so the combustible gases 321 is able to expand in the sealed housing 100.

In the lithium battery module of the disclosure, the sealed housing 100 provides an isolated space from the environment for accommodating the soft-shell capacitor assembly 300. The sealed housing 100 blocks water vapor to prevent the soft-shell capacitor assembly 300 from contacting the water vapor, thereby extending the lifespan of the soft-shell capacitor assembly 300. Furthermore, the sealed housing 100 can sever as a buffer space for the combustible gases 321 because it can enclose the combustible gases 321. This prevents excessive combustible gases 321 from discharging to the environment, thereby significantly reducing the possibility of ignition.

What is claimed is:

1. A lithium battery module, comprising:
a sealed housing on which a one-way exhaust structure is disposed;
a fixture accommodated in the sealed housing; and
at least one soft-shell capacitor assembly disposed on the fixture, wherein the soft-shell capacitor assembly is pressed and fixed by the fixture while a vent is formed on the soft-shell capacitor assembly.

2. The lithium battery module according to claim 1, wherein the one-way exhaust structure comprises an air passage, a rubber sleeve and a pressing plate, the air passage is formed in a manner outwardly protruding from the sealed housing while at least one through hole is formed on the air passage, the rubber sleeve is sleeved on the air passage to make the through hole airtight, the pressing plate is fastened with the cover and presses and fixes the rubber sleeve to the air passage.

3. The lithium battery module according to claim 1, wherein the vent of each soft-shell capacitor assembly is disposed with an absorbent structure for electrolyte.

4. The lithium battery module according to claim 1, wherein the fixture comprises a pair of pressing plates and a plurality of rods, two ends of each rod are respectively connected to each pressing plate, and the soft-shell capacitor assembly is sandwiched between the pair of pressing plates.

5. The lithium battery module according to claim 4, wherein the number of the soft-shell capacitor assemblies is plural, and the soft-shell capacitor assemblies are stacked up in layers between the pair of pressing plates.

6. The lithium battery module according to claim 5, wherein the fixture comprises a plurality of elastic pieces each sandwiched between the adjacent soft-shell capacitor assemblies.

7. The lithium battery module according to claim 1, wherein the number of the soft-shell capacitor assemblies is plural, and the soft-shell capacitor assemblies are stacked up in layers at the fixture.

8. The lithium battery module according to claim 7, wherein the fixture comprises a plurality of elastic pieces each sandwiched between the adjacent soft-shell capacitor assemblies.

9. The lithium battery module according to claim 1, further comprising a control circuit board accommodated in the sealed housing, the soft-shell capacitor assemblies being electrically connected to the control circuit board.

10. The lithium battery module according to claim 1, wherein the vent is disposed with a one-way exhaust structure.

11. The lithium battery module according to claim 1, wherein the soft-shell capacitor assembly comprises a soft-shell, a plurality of electrodes is accommodated in the soft-shell while lithium electrolyte is filled in the soft-shell to make the electrodes be immersed in the lithium electrolyte, and the vent is formed on the soft-shell.

12. The lithium battery module according to claim 11, wherein the vent is disposed with a one-way exhaust structure.

13. The lithium battery module according to claim 1, wherein an inner surface of the sealed housing is covered by a waterproof layer which comprises metal materials.
